(19) United States
(12) Patent Application Publication
(10) Pub. No.: US 2016/0192678 A1
(43) Pub. Date: Jul. 7, 2016

(54) FEED FOR LACTATING RUMINANTS

(71) Applicant: BENEMILK OY, Raisio (FI)

(72) Inventors: Feng Wan, Issaquah, WA (US); Merja Birgitta Holma, Raisio (FI); James Edward Nocek, Auburn, NY (US); Craig Cano Beeson, Charleston, SC (US); Ilmo Pellervo Aronen, Hinnerjoki (FI)

(73) Assignee: Benemilk Oy, Raisio (FI)

(21) Appl. No.: 14/908,105

(22) PCT Filed: Jul. 30, 2013
(86) PCT No.: PCT/US13/52658

§ 371 Date: Jan. 27, 2016

(51) Int. Cl. A23K 1/16

(52) U.S. Cl. CPC A23K 1/164; A23K 1/1813; A23K 1/1634; A23K 1/1603; A23K 1/1643; A23K 1/146; A23K 1/175; A23K 1/003

(57) ABSTRACT

A feed for ruminants may include at least one derivatized fatty acid component such that ingestion of the feed by lactating ruminants may provide for an increase in the amount of milk produced by the ruminant, and/or an increase in the fat content of the milk produced.

### BACKGROUND

Increasing milk production and improving milk quality have always been a major goal when feeding lactating dairy animals, such as dairy cows. Depending on the animal, the feed components may vary considerably. For example, ruminants are able to digest fibrous plant based foods, or roughage, that are indigestible to non-ruminants. Ruminants, may include lactating animals such as, for example, cattle, goats, sheep, and dairy cows. Some examples of roughages include hay, grass silage, corn silage, straw and pasture, as well as various whole grain/leguminous silages and other fodders.

For efficient milk production, ruminants may also be given, in addition to roughages, a feed concentrate that may include energy components (that is, carbohydrates and fat), protein components, minerals, micronutrients and vitamins. Some examples of common feed items include grain feeds (corn, oats, barley, wheat), vegetable oilseed crushes or meal (rapeseed) and soybeans. A large variety of different byproducts from food industry may also be used.

Although there has been an increase in the milk production of cows during the last decades, the degree of utilization of feed has essentially not improved. The same amount of energy intake per kilogram of milk is needed now as was needed decades ago. When the utilization of energy becomes more effective, milk production may increase and the concentration of protein and fat in the milk may increase.

Most attempts for increasing milk fat content tend to lower milk production and/or protein content, and result in other undesired effects, such as increased trans fatty acid levels, on the fatty acid profile of the milk fat. Therefore, there still remains a need for new compositions and methods that can increase production of milk with increased levels of milk fat.

### SUMMARY

In an embodiment, a nutriment for ruminants includes at least one fatty acid moiety derivatized with a derivatizing moiety.

In an embodiment, a method for making a feed composition for ruminants includes providing at least one fatty acid moiety derivatized with a derivatizing moiety, and combining the at least one fatty acid moiety derivatized with a derivatizing moiety with at least one nutriment to make the feed composition.

In an embodiment, a method for increasing at least one of an amount of milk produced by a lactating ruminant and a milk fat content in the milk produced by the lactating ruminant, includes feeding the lactating ruminant a feed composition having at least one fatty acid moiety derivatized with a derivatizing moiety.

### BRIEF DESCRIPTION OF THE FIGURES

FIGS. 1A and 1B depict a representation of ruminant feed with derivatized fatty acid moieties according to embodiments.

FIGS. 2A-2E depict derivatized palmitic acid moieties according to embodiments.

### DETAILED DESCRIPTION

With relation to the description as presented herein, a “ruminant” is a class of mammal with a multiple chamber stomach that gives the animal an ability to digest cellulose-based food by softening it within the first chamber (rumen) of the stomach and regurgitating the semi-digested mass. The regurgitate, known as cud, is then chewed again by the ruminant. Specific examples of ruminants include, but are not limited to, cattle, bison, buffaloes, yaks, camels, llamas, giraffes, deer, pronghorns, antelopes, sheep, and goats. The milk produced by ruminants is widely used in a variety of dairy-based products. Dairy cows are of considerable commercial significance for the production of milk and processed dairy products such as, for example, yogurt, cheese, whey, and ice cream.

The formation of milk in the mammary gland is a complex enzymatic process regulated by hormones, requiring a lot of ATP energy at the cell level, as well as suitable starting materials and enzymes. The main components of milk, that is, lactose, protein, and fat, are synthesized in the cells of the udder. Glucose availability in the mammary gland has been regarded as the main limiting factor in milk production, in addition to the availability of some amino acids. Acetate is also an important starting material of de novo synthesis of milk fat. Acetate provides a relevant source of energy, and acetate has been determined to have a unique role in energy metabolism as part of ATP formation in the synthesis of all milk components.

In feeding of ruminants, as mentioned above, roughages may be supplemented with energy and protein components, minerals, micronutrients and vitamins, etc. The inclusion of fat has been generally minimal since the amount of added fat seldom exceeds 3 wt % of the diet. Some amounts of vegetable oils, fatty acid calcium salts, and mixtures of mainly saturated fatty acids (stearic and palmitic acids, for example) may be added to the diet. Since fats having a low iodine value are usually poorly digestible (the higher the iodine number, the greater the unsaturation, or the greater the number of C═C bonds present in the fat), most added fats have an iodine value much greater than 10. For example, soybean oil has an iodine value of about 120-136, and corn oil about 109-133.

Microbes in the rumen ferment carbohydrates of the feed to acetic acid, butyric acid and propionic acid, with propionic acid generally being the most important precursor of glucose. These acids may be absorbed through the rumen wall, and transported to the liver wherein they are converted to useful nutrients. Acetate may be consumed in the liver for producing energy. It may also be converted to longer fatty acids in the liver. These fatty acids may function as precursors to fat. Part of the acetate may be transferred with the blood circulation to the mammary gland, where the acetate may be used for the synthesis of fatty acids having generally sixteen or fewer carbon. Butyric acid may also be used as a precursor of milk fat.

Part of the protein in the feed generally degrades by means of microbes in the rumen to ammonia, part of which is absorbed through the rumen wall and may be converted to urea in the liver. Another part of the protein may be converted by microbes to microbial protein, which may then be absorbed from the small intestine as amino acids. Still another part of the protein in the feed may be transported directly to the small intestine and may be absorbed as amino acids, such as the protected amino acids. Under some conditions, high protein intake from the feed may lead to increased urea concentrations of milk, and does not thus necessarily increase milk protein content.

Fat in the feed may be modified by the rumen, and thus the milk fat profile may generally not be the same as the profile of fat in the feed. All fats which are not completely inert in the rumen may decrease feed intake and rumen digestibility of the feed material. Milk composition and fat quality may be influenced by the diet of the ruminant. Oil feeding (for example, vegetable oils) may have negative effects on both rumen function and milk formation. The milk protein concentration may be lowered, the fat concentration may be decreased, the proportion of trans fatty acids may be increased and the properties of the fat during industrial milk processing may be weakened. Typical milk fat may contain more than 70 wt % of saturated fatty acids, and about one third of the milk fat may be palmitic acid.

The detrimental effect of oil and fat feeding may be diminished by preventing triglyceride fat hydrolysis. Fat hydrolysis may be decreased for example by protecting fats with formaldehyde treated casein. Another alternative is to make insoluble fatty acid calcium salts whereby hydrogenation in the rumen may be avoided. However, the disadvantages of fatty acid salts limit their usability in feeds. The pungent taste of the salts generally may lead to a decreased feed intake. The salts may also interfere with pelletizing of the feed.

The nutrients obtained from the feed may be metabolized in a number of ways before forming milk components. The saturated and unsaturated fatty acids in the feed that are transported to the small intestine may be absorbed as micelles and may be converted in the small intestine wall to triglycerides, phospholipids and lipoproteins. These may be transported in the lymph, past the liver and into blood circulation for the needs of, for example, muscles and the mammary gland. Thus, any long-chain fatty acids absorbed from the diet cannot cause fatty liver. Fatty liver arises when the animal loses weight, and often occurs when metabolizing high amounts of saturated fatty acids in the liver.

Cell energy is generated in the mitochondria. Mitochondria produce energy, adenosine triphosphate (ATP), for the needs of the whole cell metabolism system. Cells, also the cells of a mammary gland, contain dozens of mitochondria. Particularly the mammary gland and the heart muscle need high amounts of energy. It has been determined that certain nutrient factors may enhance the mitochondrial function. ATP is the energy form which the cell uses for various needs. The intermediate product in ATP formation is called active acetic acid (acetyl-CoA).

A key measure in energy consumption is acetyl-CoA. Acetyl-CoA is generally obtained from carbohydrates and fats, and, in case of lack of energy, also from carbon chains of proteins, a process which is not economical. Acetyl-CoA may be obtained from carbohydrates via the pyruvic acid pathway which is important for non-ruminants but less significant in ruminants. The main source of acetyl-CoA in ruminants, in addition to the acetic acid formed in the rumen, is the β-oxidation of fatty acids. A ruminant does not use much glucose to produce acetyl-CoA. For that purpose acetate is used. The acetate is partly derived from β-oxidation of fatty acids, wherein palmitic acid provides a significant role.

It has been determined that saturated fatty acids, such as palmitic acid, from the feed may be surprisingly suitable for producing acetic acid and also acetyl-CoA. Further, when suitable enzymes and nutritional factors enhancing mitochondrial function are present, the availability of energy from the mitochondria is flexible and follows the demand. Palmitic acid is essentially a good energetic preform wherefrom energy can “easily” be taken for use.

The saturated fat, palmitic acid, has been determined to be an important source of energy. Palmitic acid is also used in several cell functions and in functional molecules for several different tasks. Enzymes can synthesize palmitic acid, for example, in the liver and in the mammary gland. Different tissues obtain energy via β-oxidation of palmitic acid. If the eight acetyl-CoAs produced from palmitic acid are used for complete oxidation in the citric acid cycle, 129 ATP molecules may be obtained from one palmitic acid molecule. When the function of mitochondria is effective, a lot of energy may be obtained from palmitic acid whenever needed.

Energy is important for the production of milk components. Lactose (a disaccharide of glucose and galactose) may be the most important factor affecting the osmotic pressure of milk and thus lactose synthesis also regulates the amount of secreted milk. About 80-85% of the carbon of milk lactose may be derived from glucose. Part of the carbon of galactose may be produced from acetate. Lactose is synthesized in the Golgi apparatus of the cells in the mammary gland, and the process requires three ATP molecules for the formation of one lactose molecule. A sufficient supply of acetate may therefore allow for glucose to be saved for lactose production.

The amino acids needed for the synthesis of milk protein may be partly obtained from the blood. Non-essential amino acids may be synthesized in the mammary gland by utilizing the carbon C2 chain of acetate, but this process also requires ATP energy. Approximately 30 mmol ATP/1 g protein is needed in this protein synthesis. The energy needed for the synthesis of milk fat varies depending on how the milk fat is formed. Part of the fatty acids may be obtained in de novo synthesis in the mammary gland, part may be obtained via the digestive tract from the feed, or after conversion in the rumen or in the liver. Further, esterification of fatty acids requires 10.5 mmol ATP per 1 g fat.

When fatty acids are synthesized in the udder (that is, de novo synthesis), about 27 mmol ATP per gram of fat is required. Therefore, the more milk fat components are obtained as fatty acids from the blood circulation, the more energy may be saved for other purposes. Short and middle-chain fatty acids are obtained only via de novo synthesis, and the long-chain fatty acids (C18 and longer) are obtained only from the blood circulation. Of the milk fatty acids, essentially only palmitic acid can be produced in both ways. In view of energy economy, it would be desirable to obtain more palmitic acid directly from the blood circulation.

The composition of milk fat usually differs significantly from the fat composition of the feed. Rumen hydrolysis, as well as hydrogenation, partly influences this difference. Also de novo synthesis from acetate takes place in the mammary gland and affects the composition of milk fat. In the liver, mostly the longer fatty acids, and also palmitic acid, are synthesized. In the udder on the other hand, mainly the short chain fatty acids, but also palmitic acid, are synthesized. A high concentration of fatty acids of ≧C18 in the diet may lower fatty acid synthesis.

Conventional feed raw materials may generally include common protein, carbohydrate, and/or fat containing materials used in feeds. The protein, carbohydrate and/or fat containing raw materials may include, for example, grains, peas, beans, molasses and vegetable oilseed crushes or meals. In addition to protein, carbohydrate, and fat containing raw materials, the feed may also contain other raw materials, such as minerals, additives and/or auxiliary agents. Additives may include micronutrients and vitamins. Examples of auxiliary agents may include pelletizing agents, such as lignin sulphates and/or colloidal clay. In an embodiment, a mixture of at least two of the protein, carbohydrate and/or fat containing raw materials may be used. In various embodiments, the protein content of the mixture may be about 0.1 wt % to about 55 wt %, about 5 wt % to about 45 wt %, or about 8 wt % to about 40 wt %. The protein content may be measured, for example, by using the Kjeldahl Nitrogen analysis method. In embodiments, the starch content of the mixture may be about 0.1 wt % to about 50 wt %, about 5 wt % to about 40 wt %, about 5 wt % to about 35 wt %, or about 5 wt % to about 20 wt %. The starch content may be measured, for example, by the method of AACCI 76-13.01 (American Association of Cereal Chemists International—Method 76-13.01—Total Starch Assay Procedure (Megazyme Amyloglucosidase/alpha-Amylase Method)).

It has been surprisingly determined that by a certain type of nutriment it is possible to energetically efficiently increase the proportion of milk fat derived from the feed, whereby energy is saved in the mammary gland for the synthesis of protein and lactose, and thereby milk production is increased. The most abundant fatty acid in milk is palmitic acid which can be obtained from both the blood circulation and via de novo synthesis. By configuring a nutriment appropriately, it may be possible to transfer fatty acids, via the digestive tract, into the blood circulation. While fatty acids may be provided in a nutriment in their standard form, in various embodiments, the fatty acids in the nutriment may be provided in the form of fatty acid moieties that have been derivatized with derivatizing moieties. The fatty acid moieties may be covalently linked with the derivatizing moiety.

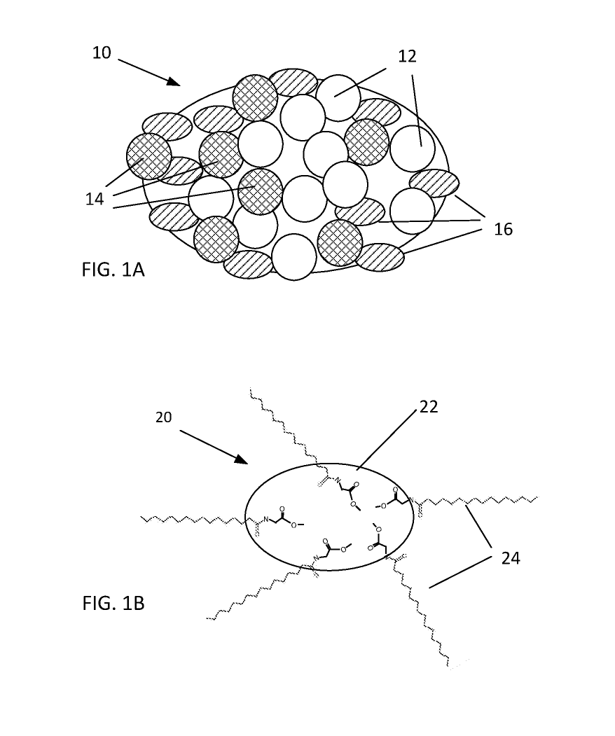

As depicted in FIG. 1A, a ruminant feed pellet 10 may include at least carbohydrate particles 12, protein particles 14, and fat components 16. The fat components 16 may include fatty acid moieties, and the fatty acid moieties may include derivatized fatty acid moieties. For clarity, additional components are not depicted. In various embodiments as discussed herein, the fat components 16 may be mixed with the other feed components 12, 14 prior to processing and pelletizing, or alternatively, prepared feed pellets may be infused with the fat components 16.

In an embodiment, as depicted in FIG. 1B, a ruminant nutriment 20 may include an ingestible carrier 22, and at least one derivatized fatty acid moiety 24 covalently linked to the carrier. In an embodiment, the derivatized fatty acid moiety 24 may be a derivatized palmitic acid moiety. In an embodiment the carrier 22 may be a polymer. Such a nutriment may be dispersed into drinking water or feed for consumption by the ruminant. For dispersal in liquid, an additional dispersant, such as a surfactant, for example, may be used to improve separation of the particles and prevent settling or clumping.

In an embodiment, a ruminant feed that increases milk production and/or the milk fat content, which may be, for example a pellet 10 of FIG. 1, may include a nutritional component, for example, carbohydrate 12 or protein 14, at least one carrier 22, and at least one derivatized fatty acid moiety 24 covalently linked to the carrier. As such, a particle 20 of FIG. 1B, may provide the fat component 16 in pellet 10 of FIG. 1A. The feed may contain at least about 4 wt % of a derivatized fatty acid moiety.

In an embodiment, the fat component may include fatty acid moieties, or a mixture of fatty acid moieties and derivatized fatty acid moieties, or derivatized fatty acid moieties, that may be infused into the feed or covalently linked to a carrier. Derivatized fatty acid moieties may include fatty acid moieties that are covalently linked to a derivatizing moiety, for example, by an ester bond, an amide bond, a phosphonate bond, a sulfonate bond, a carbamate bond, a carbonate bond, or combinations thereof.

In an embodiment, the fatty acid moiety derivatized with a derivatizing moiety may have a structural formula as represented by:

fatty acid moiety-CO-X-derivatizing moiety

wherein X is a linking group of about 1 to about 20 atoms selected from a group consisting of O, N, S, P, and C. The linking group can be understood to further include one or more hydrogen H atoms. For example, the linking group can be a methylene CH₂ group. The linking groups may be a linear or branched, substituted or non-substituted, divalent moiety independently selected from alkylene, alkenylene, alkynylene, arylene, arylene, cycloalkylene, heteroarylene, heterocyclene, acyl, amido, acyloxy, urethanylene, thioester, phosphonyl, sulfonyl, sulfonamide, sulfonyl ester, —O—, —P—, —S—, —NH—, substituted amine, or combinations thereof.

In an embodiment, the fatty acid moiety and the derivatizing moiety are covalently linked by a linking component derived from at least one of a diol, a triol, a diamine, and a triamine.

In an embodiment, the derivatized fatty acid moieties may be derivatives of saturated fatty acids. For clarification, the saturated fatty acid itself is not a derivatized fatty acid. For example, palmitic acid itself is not a derivatized palmitic acid. Some examples of saturated fatty acids may include palmitic acid, stearic acid, caprylic acid, capric acid, lauric acid, myristic acid, hexanoic acid, butyric acid, or combinations thereof. In an embodiment, the derivatized fatty acid moieties may be derivatives of unsaturated fatty acids. Some examples of unsaturated fatty acids may include myristoleic acid, palmitoleic acid, oleic acid, linoleic acid, linolenic acid, or combinations thereof. In a further embodiment, the derivatized fatty acid moieties may include derivatives of both saturated and unsaturated fatty acids.

In an embodiment, the fat component may be at least about 90 wt %, at least about 95 wt %, at least about 97 wt %, at least about 98 wt %, at least about 99 wt %, or about 100 wt % derivatized saturated free fatty acid. The feed composition may be substantially free of trans-fatty acid (unsaturated fatty acid). “Substantially free” means, within this context, that various embodiments of a diet may contain at most about 5%, at most about 4%, at most about 3%, at most about 2%, at most about 1%, at most about 0.5%, or no trans fatty acids.

The derivatizing moiety may be an amino acid, an antioxidant, co-enzyme A, phosphatidylcholine, a simple sugar, a glucogenic precursor, or combinations thereof. Some examples of amino acids may include leucine, lysine, histidine, valine, arginine, threonine, isoleucine, phenylalanine, methionine, tryptophan, alanine, asparagine, aspartate, cysteine, glutamate, glutamine, glycine, proline, serine, tyrosine, or combinations thereof. Some examples of antioxidants may include alpha-carotene. beta-carotene, ethoxyquin, BHA, BHT, cryptoxanthin, lutein, lycopene, zeaxanthin, vitamin A, vitamin C, vitamin E, vitamin K, selenium, alpha-lipoic acid, or combinations thereof. Some examples of simple sugars may include glucose, galactose, lactose, fructose, or combinations thereof. Some examples of glucogenic precursors may include glycerol, propylene glycol, molasses, propionate, glycerine, propane diol, calcium propionate, propionic acid, octanoic acid, steam-exploded sawdust, steam-exploded wood chips, steam-exploded wheat straw, algae, algae meal, microalgae, or combinations thereof.

In an embodiment, the derivatized fatty acid moiety may include a derivatized palmitic acid moiety. Further, the derivatized fatty acid moiety may consist essentially of, or consist of, derivatized palmitic acid. In embodiments, the fatty acid moiety may contain at least about 90 wt %, at least about 95 wt %, at least about 98 wt %, at least about 99 wt %, or about 100 wt % derivatized palmitic acid moiety.

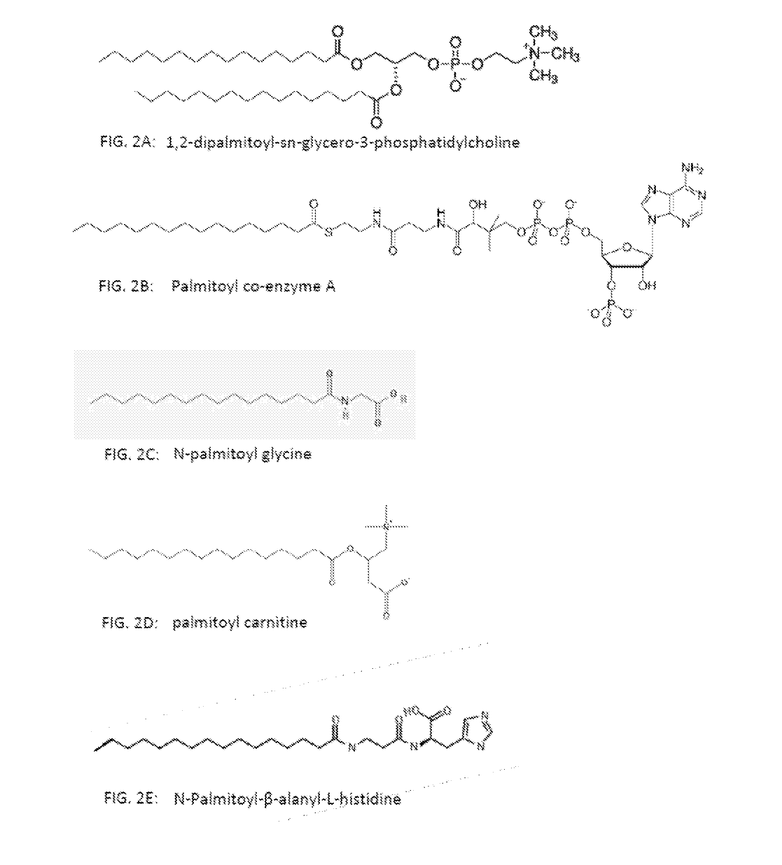

FIGS. 2A-2E depict some non-limiting examples of derivatized palmitic acid, and include, 1,2-dipalmitoyl-sn-glycero-3-phosphatidylcholine (FIG. 2A), palmitoyl co-enzyme A (FIG. 2B), N-palmitoyl glycine (FIG. 2C), palmitoyl carnitine (FIG. 2D), and N-palmitoyl-β-alanyl-L-histidine (FIG. 2E).

In FIG. 1B, a derivatized fatty acid moiety 24 may be derived from a derivatized fatty acid that has at least one functional group, and a carrier 22 may be derived from a carrier that has at least one functional group that is capable of covalently linking with a functional group of the derivatized fatty acid, to covalently link the derivatized fatty acid moiety to the carrier.

The carrier may be any of a variety of particulate materials. In various embodiments, the carrier may be feed particles, polymers, copolymers, wood particle, hay particle, grain particle, alfalfa particle, protein particle, yeast particle, corn stover particle, or combinations thereof. Some additional examples may include polysaccharides, proteins, cuticle, lignocellulose, nucleic acids, nucleotides, hemicellulose, starch, galactan, pectin, arabinogalactan, xylan, glycan, polyethylene glycol, monosaccharides, or combinations thereof.

Some examples of polymers may include carbohydrates, triglycerides, plant cuticular waxes, cutins, yeast cell wall polymers, glucans, lignans, tannins, polymerized polyphenols, proteins, chitin polymers, xylans, fructans, pullulans, or combinations thereof. Some examples of co-polymers may include plant-sourced glycoproteins (derived from plant materials).

The derivatized fatty acid moiety may be covalently linked to the carrier through a linker, and the linker may be an ether bond, thioether bond, carbonyl bond, ester bond, imino bond, amide bond, imide bond, urethane bond, urea bond, carbonate bond, sulfonyl bond, sulfonate bond, phosphonyl bond, a phosphonate bond, Schiff-base bond, a bond resultant of an Amadori rearrangement, a Up reaction, or a Diels-Alder adduct, or combinations thereof.

In an embodiment, the feed may, in some cases, not contain a high amount of fatty acid salts, such as calcium salt, because of the generally negative effect such salts may have on milk production. In embodiments, there may be at most 1 wt %, at most 0.5 wt %, at most 0.1 wt %, or at most 0.02 wt % fatty acid salts in the feed. In an embodiment, there may be substantially no or no fatty acids as salts present in the feed.

In an embodiment, the feed may, in some cases, not contain a high amount of triglycerides. In embodiments, there may be at most about 7 wt %, at most about 5 wt %, at most about 3 wt %, or at most about 1 wt % triglycerides in the feed.

In embodiments, the derivatized fatty acids may have an iodine value of at most about 4, at most about 2, at most about 1.5, or at most about 1. In embodiments, the derivatized fatty acids may be configured such that the melting point of the derivatized fatty acids may be equal to or greater than about 40° C. In alternative embodiments, the derivatized fatty acids may be configured such that the melting point of the derivatized fatty acids may be equal to or less than about 80° C. In further embodiments, the derivatized fatty acids may be configured such that the melting point of the derivatized fatty acids may be about 40° C. to about 80° C. Some specific examples of the melting points may be about 40° C., about 45° C., about 50° C., about 55° C., about 55° C., about 60° C., about 65° C., about 70° C., about 75° C., about 80, or ranges between any two of these values (including endpoints).

The total amount of the derivatized fatty acid in the feed may vary by the feed type. For example, the amount may be at least about 4 wt %. For example, the amount of derivatized palmitic acid moiety in the feed may be at least about 4 wt % of the total weight of the feed. In embodiments, some examples may include at least about 4 wt %, at least about 6 wt %, at least about 8 wt %, or at least about 10 wt %, and may vary between at least about 4 wt % to at most about 50 wt %. In embodiments, the lower limit for the total amount of the derivatized fatty acid in the feed may be at least about 10 wt %, at least about 12 wt %, at least about 15 wt %, and the upper limit may be at most about 35 wt %, at most about 30 wt %, or at most about 25 wt % by weight. If the feed is an energy concentrate feed, the total amount of the derivatized fatty acid may be about 15 wt % to about 25 wt %. In an embodiment of energy feed, the total amount of the derivatized fatty acid may be about 20 wt %. In a mineral concentrate feed, the amount of the derivatized fatty acid may be about 25 wt % to about 35 wt %. In an embodiment of mineral feed, the total amount of the derivatized fatty acid may be about 30 wt %. In an amino acid concentrate feed, the total amount of the derivatized fatty acid may be about 10 wt % to about 20 wt %, for example about 11 wt % to about 19 wt %. In an embodiment of amino acid feed, the total amount of the derivatized fatty acid may be about 15 wt %. In a protein concentrate feed, the total amount of the derivatized fatty acid may be about 10.5 wt % to about 20 wt %.

The feed may, in some cases, not contain other saturated free fatty acids other than the derivatized fatty acid moieties, or the feed may contain at most about 5 wt %, at most about 1 wt %, at most about 0.5 wt %, at most 0.1 wt % of the other saturated free fatty acids. As an example, the proportion of derivatized palmitic acid moiety of the free saturated fatty acids in a feed may be at least about 90 wt %, at least about 95 wt %, at least about 97 wt %, at least about 98 wt %, at least about 99 wt %, or about 100 wt %—wherein all of the saturated free fatty acid is provided by derivatized palmitic acid.

A feed configured as described above introduces glucose, palmitic acid and amino acids to the ruminant's metabolic system. The feed may also enhance mitochondrial function. The feed improves the degree of energy utilization in the milk production process of ruminants. When the utilization of energy is improved, milk production, that is, milk yield has been found to increase and the concentration of fat in the milk also increases. The feed intensifies fat synthesis in the mammary gland by allowing the main component of milk fat for use in the cells to be taken directly to the cells, reducing the need for synthesis by the cells, and thus saving energy. Thus, the limiting glucose may be used more effectively in lactose production whereby milk production increases. The milk protein content may also be increased if there is no need to produce glucose from amino acids, which may also be obtained directly from the feed. Such a feed may result in a reduction of weight loss at the beginning of the lactation season, and thus fertility problems may also be decreased.

It has now been determined that when animals obtain ATP energy from the acetate formed in the rumen and acetate oxidized from palmitic acid, obtain glucose from a glucogenic feed, and obtain amino acids from proteinaceous feed, both the amount of milk and the protein and fat content of the milk can be increased. The palmitic acid therefore may be obtained from such a source of fat, and in such a way that it does not disturb the rumen, worsen the digestibility of roughage, and decrease eating (feed intake).

In an embodiment of ruminant feed in which derivatized fatty acids are mixed directly with the feed, or are infused into prepared feed pellets, the feed may contain at least one emulsifier that may provide both emulsifying and pelletizing effects. Emulsifiers may be selected from the group consisting of nonionic emulsifiers. In embodiments, the HLB value (hydrophilic-lipophilic balance) of the emulsifier may be at least about 5, or at least about 7, and an upper value may be at most about 14. Castor oil based emulsifiers may be mentioned as examples of preferred emulsifiers. In embodiments, the amount of emulsifier used in the feed may be about 0.01 wt % to about 2 wt %, about 0.02 wt % to about 1 wt %, about 0.02 wt % to about 0.5 wt %, or about 0.05 wt % to about 0.06 wt %. The amount of emulsifier by the weight of the fatty acid mixture may be about 0.2 wt % to about 2.0 wt %, about 0.5 wt % to about 1.5 wt %, or about 0.8 wt % to about 1.2 wt %.

In an embodiment, a feed that contains a derivatized fatty acid moiety wherein at least about 90 wt % of the fatty acid is palmitic acid, and also contains a suitable emulsifier processed in a suitable way, may be able to improve milk yield, increases milk fat content (% by weight) and may also increase milk protein content (% by weight).

The feed may additionally contain one or more nutritional components selected from the group consisting of carbohydrate sources, nitrogen sources, amino acids, amino acid derivatives, minerals, vitamins, antioxidants, glucogenic precursors and/or components which enhance mitochondrial function.

A surprisingly large increase in milk production may be obtained when cows are fed a feed which contains a combination of palmitic acid moieties, an emulsifier, a glucogenic precursor, amino acids and certain components which intensify cell level function (that is, mitochondria function enhancing components). It has been determined that the addition of palmitic acid moieties, such as derivatized palmitic acid moieties, as discussed herein, together with suitable feed components, provides for improved energy efficiency of ruminant feeding and feed utilization. In an embodiment, a feed may contain derivatized palmitic acid moieties that are completely inert in the rumen and the utilization of which in the ruminant's metabolic system is affected or surprisingly improved by the preparation process and suitable components of the feed.

In an embodiment, the feed may include at least one glucogenic precursor. The glucogenic precursor may be selected from the group consisting of glycerol, propylene glycol, molasses, propionate, glycerine, propane diol, calcium propionate, propionic acid, octanoic acid, steam-exploded sawdust, steam-exploded wood chips, steam-exploded wheat straw, or combinations thereof. In embodiments, the amount of the glucogenic precursor in the feed may be about 1 wt % to about 20 wt %, or about 5 wt % to about 15 wt %.

Further, the feed may also contain added amino acids and/or amino acid derivatives. The added amino acids or derivatives may be amino acids or derivatives selected from the group consisting of the essential amino acids leucine, lysine, histidine, valine, arginine, threonine, isoleucine, phenylalanine, methionine, tryptophan, or combinations thereof. In an embodiment, the added amino acids or derivatives may be amino acids or derivatives selected from the group consisting of the non-essential amino acids or derivatives, and may include amino acids and derivatives of alanine, asparagine, aspartate, cysteine, glutamate, glutamine, glycine, proline, serine, tyrosine, or combinations thereof. The amino acids and derivatives may also include amino acids and derivatives of both non-essential and essential amino acids. The amount of added amino acids in the feed may be about 0.1 wt % to about 2 wt %, or about 0.5 wt % to about 1 w %.

In embodiments, the feed may include added components that enhance the function of mitochondria. Mitochondrial function enhancing components may be selected from the group consisting of carnitine, biotin, other B vitamins, omega-3-fatty acids, ubiquinone and combinations thereof. In embodiments, the amount of the mitochondrial function enhancing components may be about 0.5 wt % to about 5 wt %, or about 1 wt % to about 3 wt %.

In embodiments, the carbohydrate source may be selected from the group consisting of algae, algae meal, microalgae, sugar beet pulps, sugar canes, wheat bran, oat hulls, grain hulls, soybean hulls, peanut hulls, wood, brewery by-product, beverage industry by-products, forages, roughages, molasses, sugars, starch, cellulose, hemicellulose, wheat, corn, oats, sorghum, millet, barley, barley fiber, barley hulls, barley middlings, barley bran, malting barley screenings, malting barley and fines, malt rootlets, maize bran, maize middlings, maize cobs, maize screenings, maize fiber, millet, rice, rice bran, rice middlings, rye, triticale, brewers grain, coffee grinds, tea leaf ‘fines’, citrus fruit pulp, rind residues, or combinations thereof.

In embodiments, the nitrogen source may be selected from the group consisting of microalgae, oilseed meals, soy meals, bean meals, rapeseed meals, sunflower meals, coconut meals, olive meals, linseed meals, grapeseed meals, distiller dry grains solids, camelina meal, camelina expeller, cotton seed meal, cotton seed expeller, linseed expeller, palm meal, palm kernel meal, palm expeller, rapeseed expeller, potato protein, olive pulp, horse beans, peas, wheat germ, corn germ, corn germ pressed fiber meal residue, corn germ protein meal, whey protein concentrate, milk protein slurries, milk protein powders, animal protein, or combinations thereof.

In embodiments, the mineral may be a salt of Ca, Na, Mg, P, K, Mn, Zn, Se, Cu, I, Fe, Co, Mo, or combinations thereof. These minerals may be provided using any of a number of mineral sources. In general, any GRAS (generally recognized as safe) mineral source may be used which provides a bioavailable mineral. Some examples include copper sulphate, sodium selenite, selenium yeast, and chelated minerals. Table 1 shows some examples of suitable mineral sources.

TABLE 1
GRAS Mineral Sources

| | | | |
|---|---|---|---|
| Calcium Acetate | Calcium Carbonate | Calcium Chloride | Calcium Gluconate |
| Calcium Hydroxide | Calcium Iodate | Calcium | Calcium Oxide |
| | | Iodobehenate | |
| Calcium Sulfate | Cobalt Acetate | Cobalt Carbonate | Cobalt Chloride |
| (anhydrous or | | | |
| dihydrate) | | | |
| Cobalt Oxide | Cobalt Sulfate | Dicalcium Phosphate | Magnesium Acetate |
| Magnesium Carbonate | Magnesium Oxide | Magnesium Sulfate | Manganese Carbonate |
| Manganese Chloride | Manganese Citrate | Manganese Gluconate | Manganese |
| | (soluble) | | Orthophosphate |
| Manganese Oxide | Manganese | Manganese Sulfate | Monocalcium Phosphate |
| | Phosphate (dibasic) | | |
| Monosodium | Potassium Acetate | Potassium | Potassium Carbonate |
| Phosphate | | Bicarbonate | |
| Potassium•chloride | Potassium Iodate | Potassium Iodide | Potassium Sulfate |
| Sodium Acetate | Sodium Chloride | Sodium Bicarbonate | Disodium Phosphate |
| Iron Ammonium | Iron Carbonate | Iron Chloride | Iron Gluconate |
| Citrate | | | |
| Iron Oxide | Iron Phosphate | Iron Pyrophosphate | Iron Sulfate |
| Reduced Iron | Sodium Iodate | Sodium Iodide | Sodium Tripolyphosphate |
| Sodium Sulfate | Tricalcium | Zinc Acetate | Zinc Carbonate |
| | Phosphate | | |
| Zinc Chloride | Zinc Oxide | Zinc Sulfate | |

In embodiments, the vitamin may be selected from the group consisting of vitamin A, vitamin C, vitamin D, vitamin E, vitamin K, vitamin B1, vitamin B2, pantothenic acid, niacin, biotin, choline, or combinations thereof.

In embodiments, the antioxidant may be selected from the group consisting of alpha-carotene, beta-carotene, ethoxyquin, BHA, BHT, cryptoxanthin, lutein, lycopene, zeaxanthin, vitamin A, vitamin C, vitamin E, selenium, alpha-lipoic acid, or combinations thereof.

The feed may essentially be any type of feed, and may include any compound feed (industrially produced mixed feed) intended for feeding of a lactating animal. Some examples may include complete feeds (compound feed containing all main nutrients except nutrients obtained from roughage), and concentrate feeds, such as protein concentrate feeds, mineral concentrate feeds, energy concentrate feeds, and amino acid concentrate feeds. The energy concentrate feeds, amino acid concentrate feeds, and mineral concentrate feeds may provide better results. The term “concentrate feed” generally refers to a compound feed which has a high concentration of the indicated substances. Typical concentrate feed are used in combination with other feed, such as grains. Various embodiments of concentrated feed as described herein may include more nutrients than conventional supplements.

In embodiments, a complete feed may contain about 15 wt % to about 50 wt %, about 16 wt % to about 40 wt %, or about 17 wt % to about 35 wt % protein and/or amino acids and/or peptides. This amount may include mainly proteins, but also may include peptides and small amounts of free amino acids. The amino acid and/or protein and/or peptide content may be measured, for example, by using the Kjeldahl Nitrogen analysis method. In an embodiment, an amino acid concentrate feed or protein concentrate feed may contain about 20 wt % to about 40 wt %, or about 24 wt % to about 35 wt % amino acids and/or protein. In other embodiments, a mineral concentrate feed may contain less than about 25 wt %, or less than about 20 wt % of amino acids and/or protein. In further embodiments, an energy concentrate feed may contain about 5 wt % to about 50 wt %, or about 8 wt % to about 40 wt % amino acids and/or protein.

In an embodiment, a complete feed may contain about 4 wt % to about 50 wt %, about 6 wt % to about 45 wt %, about 8 wt % to about 40 wt %, or about 12 wt % to about 35 wt % starch. The starch content may be measured, for example, by the AACCI 76-13.01 method. An amino acid concentrate feed or protein concentrate feed may contain about 1 wt % to about 30 wt %, about 5 wt % to about 20 wt % starch. A mineral concentrate feed may contain less than about 20 wt %, or less than about 15 wt % starch. An energy concentrate feed may contain about 5 wt % to about 50 wt %, or about 5 wt % to about 40 wt % starch.

In an embodiment, a feed may contain derivatized palmitic acid and an emulsifier, and the feed may be processed in a way that improves digestion of derivatized palmitic acid in the small intestine. When derivatized palmitic acid is suitably processed and included with the feed particles together with an emulsifier, the feed may slow fermentation of feed particles in the rumen, and in addition, have improved digestibility. In the small intestine the fatty acids of the feed particles may be converted into emulgated micelles before they can be absorbed through the intestine wall. Lysolecithin of bile acids also function as an emulsifier in the small intestine but this effect is intensified when the feed has been processed with an additional emulsifier.

A process for producing a ruminant nutriment containing derivatized fatty acids covalently linked to carrier particles may include covalently bonding at least one derivatized fatty acid moiety to a carrier to produce fatty acid particles, and dispersing the fatty acid particles in at least one of ruminant feed and drinking water for ingestion by the ruminant. For a feed, the dispersing may include mixing the fatty acid particles with ruminant feed to produce a feed mixture, wherein the derivatized fatty acid moiety is present in the feed mixture at a concentration of at least about 4 wt %. In an embodiment, the fatty acid may be palmitic acid.

After mixing the fatty acid particles with ruminant feed, the mixture may be extruded, or pelletized, or processed in other ways to produce a feed product which may be taken orally by the ruminant breed to which it is to be fed. Prior to, or during mixing, additional nutritional components, such as a carbohydrate source, a nitrogen source, an amino acid, an amino acid derivative, a mineral, a vitamin, an antioxidant, a glucogenic precursor, or combinations thereof, may also be added to the feed mixture.

A process for preparing a feed containing derivatized fatty acid may include adding the derivatized fatty acid to a feed raw material. As provided herein, the raw materials may include any of carbohydrate sources, nitrogen sources, amino acids, amino acid derivatives, minerals, vitamins, antioxidants, glucogenic precursors and/or components which enhance mitochondrial function.

Any or all of the materials may be ground to provide components that may be of a particular size, varying sizes, or to provide uniformly sized components. Grinding may provide various benefits, such as improving certain characteristics of the feed. For instance, even and fine particle size may improve the mixing of the various ingredients. According to certain embodiments, grinding may be configured to decrease a particle size of certain components of the feed composition, for example, to improve the digestibility of the nutrients, and/or to increase the palatability of the feed.

Grinding may be performed by various grinding devices, such as a hammer mill, a roller mill, a disk mill, or the like. The feed mixture and/or portions thereof may be ground to various sizes, such as particle size (for instance, measured in millimeters), mesh sizes, surface areas, or the like. According to some embodiments, the feed mixture and/or portions thereof may be ground to an average particle size of about particle size of about 0.05 mm to about 10 mm More particularly, the feed mixture may be ground to produce a granular material having an average particle size of about 0.05 mm, about 0.1 mm, about 0.2 mm, about 0.5 mm, about 1.0 mm, about 2.0 mm, about 3.0 mm, about 4.0 mm, about 5.0 mm, about 6.0 mm, about 7.0 mm, about 8.0 mm, about 9.0 mm, about 10.0 mm, or any value or range between any two of these values. In some embodiments, the feed mixture may be ground so that about 20% to 50% of the ground particles are retained by a mesh having openings with a size of about 10 mm and so that about 70% to about 90% of the ground particles are retained by a mesh having openings with a size of about 1 mm. In some embodiments, the various components may have a varying distribution of particle sizes based upon the ingredients. For example, in embodiments containing one or more wheat ingredients, the particle size may be distributed so that about 95% of the ground wheat ingredients are retained by a mesh having openings with a size of about 0.0625 mm and so that about 65% of the ground wheat ingredients are retained by a mesh having openings with a size of about 1.0 mm. In another example, such as embodiments containing one or more barley ingredients, the particle size may be distributed so that about 95% of the ground barley ingredients are retained by a mesh having openings with a size of about 0.0625 mm and so that about 60% of the ground barley ingredients are retained by a mesh having openings with a size of about 1.0 mm. The varying mesh sizes of each ingredient may be independent of mesh sizes for other ingredients.

After mixing of the various components, the mixture may be heated to a temperature above the melting temperature of the derivatized fatty acid for a period of time to sufficiently melt the derivatized fatty acids. This gradually melts the derivatized fatty acid so that the derivatized fatty acid may be evenly absorbed into and onto the surface of feed particles. As previously discussed, this may be done under the influence of a suitable emulsifier.

In general, any heat treatment procedure that leads to a feed in which the derivatized fatty acids are evenly distributed inside and on the surface of the feed particles under the influence of a suitable emulsifier, may be suitable. The treatment may be performed in a long term conditioner, in a short term conditioner, in an expander and/or in a pelletizer. Any conventionally used conditions (temperature, pressure, moisture and time) in these processes may be suitable. In embodiment, the feed may be prepared in a long term conditioner or expander. A long term conditioner may provide improved results. In some embodiments, the feed mixture may be extruded, and if desired, pelletized after the extrusion.

In an embodiment, the carbohydrate source and the nitrogen source may be grinded to desired fineness prior to mixing so that a homogenous blend may be obtained to provide improved processability during any subsequent extrusion. In an embodiment, the derivatized fatty acids may be melted prior to introducing the derivatized fatty acids into the feed mixture. Alternatively, the saturated fatty acid derivatives may also be dispersed in one or more liquid carriers, for example, water, to obtain a liquid suspension or an emulsion.

In an embodiment, the carbohydrate source and the nitrogen source may be mixed first, and the resulting mixture extruded to obtain feed pellets. The feed composition may be prepared by spraying melted fatty acid derivatives, or the liquid suspension or emulsion of the fatty acid derivatives onto the feed pellets in a rotating and optionally heated disc.

In an embodiment, the added derivatized fatty acid may be treated with an emulsifier in the preparation process of the feed mixture, so that the resultant product may have the fatty acid mixture substantially evenly applied within and on the surface of feed particles, so that utilization of nutrients may be enhanced and the digestibility of fat may be improved. In various embodiments, the degree of utilization of the feed may be increased by about 5%, or about 10%, or about 15% when calculated as the efficiency of utilization of metabolizable energy intake for milk production (kl). Unlike several other high-fat feeds, a feed according to an embodiment as described herein may also be palatable, even highly attractive for ruminants, for example, cows. Embodiments of the feed may not therefore result in a decrease in feed intake as compared to a feed which does not contain added fats (the fat percentage of a feed that does not contain added fats may typically be about 2 wt % to about 4 wt %).

In an embodiment, a feed may be configured as an energy concentrate feed or a mineral concentrate feed, and may contain in addition to derivatized palmitic acid, a glucose source, and at least one of propylene glycol, glycerol and salts of propionic acid (sodium, calcium). The energy concentrate feed or mineral concentrate feed may also contain small amounts of mitochondrial function enhancing components, such as carnitine, biotin, other B vitamins, omega-3-fatty acids, ubiquinone, and combinations thereof. These concentrate feeds may also contain added amino acids. An amount of derivatized palmitic acid in an energy concentrate feed may be between about 15 wt % to about 25 wt %, and in an embodiment may be about 20 wt %. In a mineral concentrate feed the content of derivatized palmitic acid may be about 25 wt % to about 35 wt %, and in an embodiment, may be about 30 wt %.

In an embodiment, the feed may be an amino acid concentrate feed that contains, in addition to derivatized palmitic acid, an emulsifier, glucose sources (a glucogenic precursor) and also amino acids. The nutrients in the feed may be utilized more effectively only after the cell level energy metabolism has been intensified with the aid of palmitic acid. The added amino acids may include methionine, lysine or histidine, or any combinations thereof. In one embodiment the amino acid concentrate feed may also contain components enhancing mitochondrial function, especially as regards beta oxidation and fat synthesis. Such components may include for example carnitine, biotin, other B vitamins, omega-3-fatty acids, ubiquinone, and combinations thereof. An amount of derivatized palmitic acid in an amino acid concentrate feed may be about 10 wt % to about 20 wt %, and in an embodiment, may be about 15 wt %.

A feed prepared and configured as discussed herein may be fed to a ruminant or provided to the ruminant for ingestion. Ingestion of the feed can deliver a daily amount of derivatized fatty acid moiety. In embodiments, the daily amount of derivatized fatty acid may be about 0.2 kg/day to about 1.0 kg/day, or about 0.3 kg/day to about 0.8 kg/day, or about 0.4 kg/day to about 0.7 kg/day. Some specific examples of the daily amount of the derivatized fatty acid may be about 0.2 kg/day, about 0.3 kg/day, about 0.4 kg/day, about 0.5 kg/day, about 0.6 kg/day, about 0.7 kg/day, about 0.8 kg/day, about 0.9 kg/day, about 1.0 kg/day, or ranges between any two of these values (including endpoints).

The delivery may also be expressed as an amount of derivatized fatty acid ingested via the feed per amount of produced milk. In embodiments, the amounts may be configured to provide about 1 g to about 30 g fatty acid per kg milk/day, about 6 g to about 16 g fatty acid per kg milk/day, or about 10 g fatty acid per kg milk/day. These daily amounts, or amounts per kg milk production per day can suitably be applied in any method or use disclosed herebelow. The daily amounts disclosed above may be the amounts of palmitic acid moieties provided by the derivatized palmitic acids.

In accordance with the discussion presented herein, a method for increasing milk production of a lactating animal and/or increasing the concentrations of protein and fat in milk is also provided. The method includes feeding a lactating ruminant a feed composition comprising at least one fatty acid moiety derivatized with a derivatizing moiety. The feed is provided to the ruminant for ingestion.

In an embodiment, the method includes feeding a lactating ruminant a feed composition comprising at least one fatty acid moiety covalently linked with a derivatizing moiety. The fatty acid moiety and the derivatizing moiety may be covalently linked by an ester bond, an amide bond, a phosphonate bond, a sulfonate bond, a carbamate, a carbonate bond, or combinations thereof.

In an embodiment, the method includes feeding a lactating ruminant a feed composition comprising at least one fatty acid moiety derivatized with a derivatizing moiety and having a structural formula: fatty acid moiety-CO-X-derivatizing moiety, wherein X is a linking group of about 1 to about 20 atoms selected from a group consisting of O, N, S, P, and C. The linking group can be understood to further include one or more hydrogen H atoms. For example, the linking group can be a methylene CH₂ group. The linking group may be a linear or branched, substituted or non-substituted, divalent moiety independently selected from alkylene, alkenylene, alkynylene, arylene, arylene, cycloalkylene, heteroarylene, heterocyclene, acyl, amido, acyloxy, urethanylene, thioester, phosphonyl, sulfonyl, sulfonamide, sulfonyl ester, —O—, —P—, —S—, —NH—, substituted amine, or combinations thereof.

In an embodiment, the method includes feeding a lactating ruminant a feed composition comprising at least one fatty acid moiety derivatized with a derivatizing moiety, wherein the fatty acid moiety may be a moiety of palmitic acid, stearic acid, caprylic acid, capric acid, lauric acid, myristic acid, hexanoic acid, butyric acid, or combinations thereof, and the derivatizing moiety may be a moiety of an amino acid, an antioxidant, co-enzyme A, phosphatidylcholine, a simple sugar, a glucogenic precursor, or combinations thereof.

In various embodiments, the method may include feeding the lactating ruminant any variant of feed as presented herein. For example, the fatty acid moiety in the feed may be a palmitic acid moiety, and the palmitic acid moiety may be present in the feed at a concentration of at least about 4 wt %, or at least about 10 wt %. In another variant, the feed may contain less than about 5 wt % trans-fatty acid, or no trans fatty acid.

In an embodiment, the method includes feeding a lactating ruminant a feed composition comprising at least one palmitic acid moiety derivatized with a derivatizing moiety, and the feeding includes providing to the lactating ruminant an amount of the feed composition to provide the lactating ruminant with a daily amount of about 0.2 kg to about 1 kg palmitic acid moiety.

In an embodiment, the method includes feeding a lactating ruminant a feed composition comprising at least one palmitic acid moiety derivatized with a derivatizing moiety, and the feeding includes determining an average amount of milk produced per day for the lactating ruminant, and providing to the lactating ruminant an amount of the feed composition to provide the lactating ruminant with a daily amount of about 1 g to about 30 g palmitic acid moiety per kg milk produced per day.

In an embodiment, the method includes feeding a lactating ruminant a feed composition comprising at least one palmitic acid moiety derivatized with a derivatizing moiety, and the feeding includes determining an average amount of milk produced per day for the lactating ruminant, and providing to the lactating ruminant an amount of the feed composition to provide the lactating ruminant with a daily amount of about 10 g palmitic acid moiety per kg milk produced per day.

A method for increasing milk fat content and/or for increasing milk production includes giving a lactating ruminant a milk fat increasing amount and/or a milk volume increasing amount of a feed configured as discussed herein. The feed is provided to the ruminant for ingestion.

A method of increasing the milk protein content includes giving a lactating ruminant a milk protein increasing amount of a feed configured as discussed herein. The feed is provided to the ruminant for ingestion.

Methods can optionally further include recovering the milk produced by a lactating ruminant to which a feed configured as discussed herein is fed.

A method for using derivatized palmitic acid for preparing a ruminant feed includes providing an amount of added derivatized palmitic acid that is at least about 4 wt %, and, during the preparation process, covalently bonding the derivatized palmitic acid with an ingestible carrier particle. Alternatively, the method can include providing at least one derivatized palmitic acid, and adding it to ruminant feed at a concentration of at least about 4 wt %. The method can optionally further include covalently bonding the derivatized palmitic acid with an ingestible carrier particle.

Another method for using derivatized palmitic acid for preparing a ruminant feed includes providing an amount of added derivatized palmitic acid that is at least about 4 wt %, and, during the preparation process, applying the derivatized palmitic acid both inside and on the surface of feed raw material particles. Alternatively, the method can include providing at least one derivatized palmitic acid, and adding it to ruminant feed particles at a concentration of at least about 4 wt % such that the derivatized palmitic acid is present both inside and on the surface of the feed particles.

A method for using derivatized palmitic acid for increasing milk production of a lactating animal and/or for increasing concentrations of protein and fat in milk includes giving a lactating animal one or more feeds which provide the animal with a daily amount of derivatized palmitic acid. For example, the daily amount can be about 0.2 kg/day to about 1.0 kg/day, or about 0.3 kg/day to about 0.8 kg/day, or about 0.4 kg/day to about 0.7 kg/day. Some specific examples of the daily amount of the derivatized fatty acid include about 0.2 kg/day, about 0.3 kg/day, about 0.4 kg/day, about 0.5 kg/day, about 0.6 kg/day, about 0.7 kg/day, about 0.8 kg/day, about 0.9 kg/day, about 1.0 kg/day, or ranges between any two of these values. The method may also include preparing the feeds with at least one emulsifier, and using derivatized palmitic acid that may be essentially pure. All other features of embodiments disclosed herein for the feeds are applicable for the disclosed uses.

In embodiments, a ruminant compound feed may include:
total lipids that may be in an amount of about 10.1 wt % to about 57 wt %, or about 10.5 wt % to about 45 wt %, or about 10.5 wt % to about 40 wt %, or about 10.5 wt % to about 30 wt %, or about 10.5 wt % to about 20 wt %, or about 11 wt % to about 14 wt %;
derivatized palmitic acid that may be in an amount of about 10.1 wt % to about 50 wt %, or about 10.1 wt % to about 35 wt %, or about 10.1 wt % to about 25 wt %;
proteins that may be in an amount of about 15 wt % to about 50 wt %, or about 16 wt % to about 40 wt %, or about 17 wt % to about 35 wt %; and
starch in an amount of about 4 wt % to about 50 wt %, or about 6 wt % to about 45 wt %, or about 8 wt % to about 40 wt %, or about 12 wt % to about 35 wt %; and
   the amount of derivatized palmitic acid may be at least about 40 wt %, or at least about 45 wt %, or at least about 50 wt %, or at least about 55 wt %, or at least about 60 wt %, or at least about 65 wt %, or at least about 70 wt %, or at least about 75 wt %, or at least about 80 wt %, or at least about 85 wt %, or at least about 90 wt % of the total lipids.

In a variation thereof, the feed may also contain at least one emulsifier. The emulsifier may be a non-ionic emulsifier and may have an HLB value of at least about 5, or at least about 7, and may have an upper limit of at most about 14. In some embodiments, the HLB value can be about 5 to about 7, about 5 to about 14, about 7 to about 14, or about 7. Specific examples of HLB values include about 5, about 6, about 7, about 8, about 9, about 10, about 11, about 12, about 13, about 14, and ranges between any two of these values (including endpoints). The emulsifier may be a castor oil based emulsifier.

The ruminant compound feed may be a complete feed, and may be in the form of pellets or granules. The ruminant compound feed may additionally include at least one component selected from the group consisting of a glucogenic precursor, for example in an amount of about 1 wt % to about 20 wt %, or about 5 wt % to about 15 wt %; a mitochondrial function enhancing component, for example, in an amount of about 0.5 wt % to about 5 wt %, or about 1 wt % to about 3 wt %; and one or more amino acids, for example, in an amount of about 0.1 wt % to about 6 wt %, or about 1.5 wt % to about 3 wt %.

The ruminant compound feed may be obtainable by adding a derivatized fatty acid/carrier component, wherein at least about 90% of the derivatized fatty acid is derivatized palmitic acid, to conventional feed raw materials.

### Example 1

### Ruminant Feed Preparation

Feed components (as provided in Example 2) are mixed with a derivatized fatty acid moiety containing at least about 90% of derivatized palmitic acid. The derivatized fatty acid moiety is selected such that the melting point of the derivatized fatty acid moiety will be at least about 60° C. and the iodine value at the highest 4. The derivatized fatty acid moiety is mixed in a blender with the other feed components (raw materials) for about 3 minutes, an emulsifier is added, and the emulsifier and the fatty acids are heated among the feed mass in a long term conditioner for about 20 minutes at a temperature at least about 10° C. above the melting temperature of the derivatized fatty acid moiety, and at most about 85° C., in order for the derivatized fatty acid component to slowly melt and spread with the help of the emulsifier evenly inside and on the surface of the feed particles.

The feed mass is pelletized and cooled. As such, the whole feed mixture is treated with the molten fatty acid and emulsifier, and therefore, is at least partly protected from microbial degradation in the rumen. By using the feed described above, more digestible nutrients are brought to the cow's small intestine. Especially the high amount of palmitic acid, provided by the derivatized palmitic acid moiety, in bioavailable form will lead to positive changes in milk production as well as in milk composition and in feed utilization.

### Example 2

### Ruminant Feed Compositions

The following three compositions are examples of feed compositions (in wt %) that include a derivatized fatty acid (N-palmitoyl glycine) to increase blood glucose and blood palmitic acid supply for the mammary gland. The feed may be prepared as described in Example 1.

| Composition # | 1 | 2 | 3 |
|---|---|---|---|
| Feed grain (wheat, barley, oats) | 0-50 | 10-40 | 20-30 |
| Sugar beet pulp | 0-30 | 5-25 | 10-20 |
| Wheat bran | 0-30 | 5-25 | 10-20 |
| Molasses | 0-8 | 1-5 | 1-3 |
| Protein crush (rapeseed, soya) | 0-50 | 10-40 | 20-30 |
| Wheat middlings | 0-20 | 5-15 | 8-12 |
| Minerals | 0-5 | 1-4 | 2-3 |
| Premixes (vitamins, mineral | 0-2 | 0.5-1.5 | 0.8-1.2 |
| nutrients) | | | |
| Propylene glycol | 1-15 | 4-14 | 8-12 |
| Glycerol/Sodium propionate | 0-5 | 1-4 | 2-3 |
| Amino acid mixture | 0-2 | 0.1-1.5 | 0.3-0.9 |
| B vitamin mixture | 0-2 | 0.5-1.5 | 0.8-1.2 |
| Carnitine | 0-1 | 0.1-0.8 | 0.2-0.6 |
| Emulsifier (non-ionic) | 0.02-2 | 0.03-1 | 0.05-0.5 |
| N-palmitoyl glycine | 10.1-30 | 12-25 | 15-22 |

### Example 3

### Two-Month Study Confirms Efficacy of Derivatized Fatty Acid in Dairy Cow Feed

A feeding experiment is performed for about two months where a conventional complete feed is replaced by a feed that includes a derivatized fatty acid (N-palmitoyl glycine) and has the following composition (% by weight):

| | |
|---|---|
| Sugar beet pulp | 20 |
| Barley | 20 |
| N-palmitoyl glycine | 20 |
| Wheat bran | 14 |
| Oat bran | 10 |
| Propylene glycol | 10 |
| Molasses | 2 |
| Sodium bicarbonate | 2 |
| Biotin | 1 |
| Carnitine premix | 0.4 |
| Methionine premix | 0.5 |
| Emulsifier (non-ionic) | 0.1 |

The above test feed is given to one set of cows, and a standard conventional complete feed is given to a second set of cows as a reference. The following results are obtained from cows ingesting a test feed with derivatized palmitic acid in comparison to cows ingesting a reference feed that does not contain derivatized palmitic acid:

| | Reference | Test feed |
|---|---|---|
| Milk kg/d | 29.5 | 32.5 |
| Fat wt % | 3.98 | 4.43 |
| Protein wt % | 3.15 | 3.37 |

Expected results show that the milk production, as well as fat and protein concentrations increase significantly. In addition, the degree of feed utilization, measured as the efficiency of utilization of metabolizable energy intake for milk production (kl), also significantly improves.

This disclosure is not limited to the particular systems, devices and methods described, as these may vary. The terminology used in the description is for the purpose of describing the particular versions or embodiments only, and is not intended to limit the scope.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A nutriment for ruminants, the nutriment comprising at least one fatty acid moiety derivatized with a derivatizing moiety.

2. The nutriment of claim 1, wherein the fatty acid moiety is covalently linked with the derivatizing moiety.

3. The nutriment of claim 1, wherein the fatty acid moiety and the derivatizing moiety are covalently linked by an ester bond, an amide bond, a phosphonate bond, a sulfonate bond, a carbamate bond, a carbonate bond, or combinations thereof.

4. The nutriment of claim 1, wherein the fatty acid moiety and the derivatizing moiety are covalently linked by a linking component derived from at least one of a diol, a triol, a diamine, and a triamine.

5. The nutriment of claim 1, wherein the fatty acid moiety derivatized with a derivatizing moiety has a structural formula:
fatty acid moiety-CO-X-derivatizing moiety
wherein X is a linking group of about 1 to about 20 atoms selected from a group consisting of O, N, S, P, and C.

6. The nutriment of claim 5, wherein the linking group comprises a linear or branched, substituted or non-substituted, divalent moiety independently selected from alkylene, alkenylene, alkynylene, arylene, arylene, cycloalkylene, heteroarylene, heterocyclene, acyl, amido, acyloxy, urethanylene, thioester, phosphonyl, sulfonyl, sulfonamide, sulfonyl ester, —O—, —P—, —S—, —NH—, substituted amine, or combinations thereof.

7. The nutriment of claim 1, wherein the fatty acid moiety is a saturated fatty acid moiety.

8. The nutriment of claim 7, wherein the saturated fatty acid moiety comprises a moiety of palmitic acid, stearic acid, caprylic acid, capric acid, lauric acid, myristic acid, hexanoic acid, butyric acid, or combinations thereof.

9. The nutriment of claim 1, wherein the fatty acid moiety is an unsaturated fatty acid moiety.

10. The nutriment of claim 9, wherein the unsaturated fatty acid moiety comprises a moiety of myristoleic acid, palmitoleic acid, oleic acid, linoleic acid, linolenic acid, or combinations thereof.

11. The nutriment of claim 1, wherein the derivatizing moiety comprises a moiety of an amino acid, an antioxidant, co-enzyme A, phosphatidylcholine, a simple sugar, a glucogenic precursor, or combinations thereof.

12. The nutriment of claim 11, wherein the amino acid comprises leucine, lysine, histidine, valine, arginine, threonine, isoleucine, phenylalanine, methionine, tryptophan, alanine, asparagine, aspartate, cysteine, glutamate, glutamine, glycine, proline, serine, tyrosine, or combinations thereof.

13. The nutriment of claim 11, wherein the antioxidant comprises alpha-carotene. beta-carotene, ethoxyquin, BHA, BHT, cryptoxanthin, lutein, lycopene, zeaxanthin, vitamin A, vitamin C, vitamin E, vitamin K, selenium, alpha-lipoic acid, or combinations thereof.

14. The nutriment of claim 11, wherein the simple sugar comprises glucose, galactose, lactose, fructose, or combinations thereof.

15. The nutriment of claim 11, wherein the glucogenic precursor is glycerol, propylene glycol, molasses, propionate, glycerine, propane diol, calcium propionate, propionic acid, octanoic acid, or combinations thereof.

16. The nutriment of claim 1, wherein the at least one fatty acid moiety derivatized with a derivatizing moiety comprises at least one of 1,2-dipalmitoyl-sn-glycero-3-phosphatidylcholine, palmitoyl co-enzyme A, N-palmitoyl glycine, palmitoyl carnitine, and N-palmitoyl-β-alanyl-L-histidine

17. The nutriment of claim 1, wherein the nutriment is feed, and further comprises at least one of a carbohydrate source, a nitrogen source, amino acid, an amino acid derivative, a glucogenic precursor, a vitamin, a mineral, and an antioxidant.

18. The nutriment of claim 17, wherein the carbohydrate source comprises microalgae, sugar beet pulps, sugar canes, wheat bran, oat hulls, grain hulls, soybean hulls, peanut hulls, wood, brewery by-product, beverage industry by-products, forages, roughages, molasses, sugars, starch, cellulose, hemicellulose, wheat, corn, oats, sorghum, millet, barley, barley fiber, barley hulls, barley middlings, barley bran, malting barley screenings, malting barley and fines, malt rootlets, maize bran, maize middlings, maize cobs, maize screenings, maize fiber, millet rice, rice bran, rice middlings, rye, triticale, brewers grain, coffee grinds, tea leaf ‘fines’, citrus fruit pulp, rind residues, or combinations thereof.

19. The nutriment of claim 17, wherein the nitrogen source comprises microalgae, oilseed meals, soy meals, bean meals, rapeseed meals, sunflower meals, coconut meals, olive meals, linseed meals, grapeseed meals, distiller dry grains solids, camelina meal, camelina expeller, cotton seed meal, cotton seed expeller, linseed expeller, palm meal, palm kernel meal, palm expeller, rapeseed expeller, potato protein, olive pulp, horse beans, peas, wheat germ, corn germ, corn germ pressed fiber meal residue, corn germ protein meal, whey protein concentrate, milk protein slurries, milk protein powders, animal protein, or combinations thereof.

20. The nutriment of claim 17, wherein the amino acid is leucine, lysine, histidine, valine, arginine, threonine, isoleucine, phenylalanine, methionine, tryptophan, alanine, asparagine, aspartate, cysteine, glutamate, glutamine, glycine, proline, serine, tyrosine, or combinations thereof.

21. The nutriment of claim 17, wherein the amino acid derivative is a leucine derivative, lysine derivative, histidine derivative, valine derivative, arginine derivative, threonine derivative, isoleucine derivative, phenylalanine derivative, methionine derivative, tryptophan derivative, alanine derivative, asparagine derivative, aspartate derivative, cysteine derivative, glutamate derivative, glutamine derivative, glycine derivative, proline derivative, serine derivative, tyrosine derivative, or combinations thereof.

22. The nutriment of claim 17, wherein the glucogenic precursor is glycerol, propylene glycol, molasses, propionate, glycerine, propane diol, calcium propionate, propionic acid, octanoic acid, steam-exploded sawdust, steam-exploded wood chips, steam-exploded wheat straw, or combinations thereof.

23. The nutriment of claim 17, wherein the vitamin is vitamin A, vitamin C, vitamin D, vitamin E, vitamin K, vitamin B1, vitamin B2, pantothenic acid, niacin, biotin, choline, carnitine, or combinations thereof.

24. The nutriment of claim 17, wherein the mineral comprises a salt of Ca, Na, Mg, P, K, Mn, Zn, Se, Cu, I, Fe, Co, Mo, or combinations thereof.

25. The nutriment of claim 17, wherein the antioxidant comprises alpha-carotene, beta-carotene, ethoxyquin, BHA, BHT, cryptoxanthin, lutein, lycopene, zeaxanthin, vitamin A, vitamin C, vitamin E, selenium, alpha-lipoic acid, or combinations thereof.

26. The nutriment of claim 17, wherein the feed contains less than about 5 wt % trans-fatty acid.

27. The nutriment of claim 17, wherein the feed contains substantially no trans-fatty acid.

28. The nutriment of claim 17, wherein the feed does not contain trans-fatty acid.

29. The nutriment of claim 17, wherein the fatty acid moiety derivatized with a derivatizing moiety is present in the feed at a concentration of at least about 5 wt %.

30. A method for making a feed composition for ruminants, the method comprising:
providing at least one fatty acid moiety derivatized with a derivatizing moiety; and
combining the at least one fatty acid moiety derivatized with a derivatizing moiety with at least one nutriment to make the feed composition.

31. The method of claim 30, wherein the fatty acid moiety is covalently linked with the derivatizing moiety.

32. The method of claim 30, wherein:
the fatty acid moiety is a moiety of palmitic acid, stearic acid, caprylic acid, capric acid, lauric acid, myristic acid, hexanoic acid, butyric acid, myristoleic acid, palmitoleic acid, oleic acid, linoleic acid, linolenic acid, or combinations thereof; and
the derivatizing moiety is a moiety of an amino acid, an antioxidant, co-enzyme A, phosphatidylcholine, a simple sugar, a glucogenic precursor, or combinations thereof.

33. The method of claim 30, wherein the fatty acid moiety derivatized with a derivatizing moiety has a structural formula:
fatty acid moiety-CO-X-derivatizing moiety
wherein X is a linking group of about 1 to about 20 atoms selected from a group consisting of O, N, S, P, and C.

34. The method of claim 33, wherein the linking group is a linear or branched, substituted or non-substituted, divalent moiety independently selected from alkylene, alkenylene, alkynylene, arylene, arylene, cycloalkylene, heteroarylene, heterocyclene, acyl, amido, acyloxy, urethanylene, thioester, phosphonyl, sulfonyl, sulfonamide, sulfonyl ester, —O—, —P—, —S—, —NH—, substituted amine, or combinations thereof.

35. The method of claim 30, wherein the at least one nutriment is at least one carbohydrate source and at least one nitrogen source.

36. The method of claim 30, wherein the combining comprises heating of the at least one fatty acid moiety derivatized with a derivatizing moiety to at least one of coat the at least one nutriment and penetrate into the at least one nutriment to make the feed composition.

37. The method of claim 30, further comprising:
covalently bonding the at least one fatty acid moiety derivatized with a derivatizing moiety to a carrier to produce fatty acid particles; and
mixing the fatty acid particles with the nutriment to form a feed mixture; and
pelletizing the feed mixture.

38. The method of claim 30, further comprising at least one of pelletizing the feed composition into feed pellets and extruding the feed composition into feed pellets.

39. A method for increasing at least one of an amount of milk produced by a lactating ruminant and a milk fat content in the milk produced by the lactating ruminant, the method comprising feeding the lactating ruminant a feed composition comprising at least one fatty acid moiety derivatized with a derivatizing moiety.

40. The method of claim 39, wherein the fatty acid moiety is covalently linked with the derivatizing moiety.

41. The method of claim 39, wherein the fatty acid moiety and the derivatizing moiety are covalently linked by an ester bond, an amide bond, a phosphonate bond, a sulfonate bond, a carbamate, a carbonate bond, or combinations thereof.

42. The method of claim 39, wherein the fatty acid moiety derivatized with a derivatizing moiety has a structural formula:
fatty acid moiety-CO-X-derivatizing moiety
wherein X is a linking group of about 1 to about 20 atoms selected from a group consisting of O, N, S, P, and C.

43. The method of claim 42, wherein the linking group is a linear or branched, substituted or non-substituted, divalent moiety independently selected from alkylene, alkenylene, alkynylene, arylene, arylene, cycloalkylene, heteroarylene, heterocyclene, acyl, amido, acyloxy, urethanylene, thioester, phosphonyl, sulfonyl, sulfonamide, sulfonyl ester, —O—, —P—, —S—, —NH—, substituted amine, or combinations thereof.

44. The method of claim 39, wherein:
the fatty acid moiety is a moiety of palmitic acid, stearic acid, caprylic acid, capric acid, lauric acid, myristic acid, hexanoic acid, butyric acid, or combinations thereof; and
the derivatizing moiety is a moiety of an amino acid, an antioxidant, co-enzyme A, phosphatidylcholine, a simple sugar, a glucogenic precursor, or combinations thereof.

45. The method of claim 39, wherein the fatty acid moiety is a moiety of palmitic acid.

46. The method of claim 45, wherein the palmitic acid moiety is present in the feed composition at a concentration of at least about 4 wt %.

47. The method of claim 45, wherein the palmitic acid moiety is present in the feed composition at a concentration of at least about 10 wt %.

48. The method of claim 39, wherein the feed contains less than about 5 wt % trans-fatty acid.

49. The method of claim 39, wherein the feed contains substantially no trans-fatty acid.

50. The method of claim 45, wherein:
the palmitic acid moiety is present in the feed composition at a concentration of at least about 10 wt %.; and
the feed contains substantially no trans-fatty acid.

51. The method of claim 39, wherein the feed composition further comprises at least one additional feed component selected from the group consisting of a carbohydrate source, a nitrogen source, a glucogenic precursor, a vitamin, a mineral, an amino acid, and an amino acid derivative.

52. The method of claim 39, wherein:
wherein the fatty acid moiety is a moiety of palmitic acid; and
the feeding of the lactating ruminant comprises providing to the lactating ruminant an amount of the feed composition to provide the lactating ruminant with a daily amount of about 0.2 kg to about 1 kg palmitic acid moiety.

53. The method of claim 39, wherein:
the fatty acid moiety is a moiety of palmitic acid; and
the feeding of the lactating ruminant comprises:
determining an average amount of milk produced per day for the lactating ruminant; and
providing to the lactating ruminant an amount of the feed composition to provide the lactating ruminant with a daily amount of about 1 g to about 30 g palmitic acid moiety per kg milk produced per day.

54. The method of claim 39, wherein:
the fatty acid moiety is a moiety of palmitic acid; and
the feeding of the lactating ruminant comprises:
determining an average amount of milk produced per day for the lactating ruminant; and
providing to the lactating ruminant an amount of the feed composition to provide the lactating ruminant with a daily amount of about 10 g palmitic acid moiety per kg milk produced per day.
